(19) United States
(12) Patent Application Publication
(10) Pub. No.: US 2008/0315687 A1
(43) Pub. Date: Dec. 25, 2008

(54) POWER CONDITIONING UNIT

(75) Inventor: Atul SABHARWAL, Washington, DC (US)

Correspondence Address: SUGHRUE MION, PLLC, 2100 PENNSYLVANIA AVENUE, N.W., SUITE 800, WASHINGTON, DC, 20037, US

(73) Assignee: GREEN SHELTER INNOVATIONS LIMITED, Nicosia (CY)

(21) Appl. No.: 12/142,986

(22) Filed: Jun. 20, 2008

Related U.S. Application Data
(60) Provisional application No. 60/945,652, filed on Jun. 22, 2007.

(51) Int. Cl. H02J 9/00; H02H 9/00

(52) U.S. Cl. 307/68; 361/93.9

(57) ABSTRACT

A method and an apparatus, to provide controlled and regulated power supply to a power distribution board of a power conditioning unit (PCU), are disclosed. A line conditioner unit of the power conditioning unit may receive AC power supply from a mains input power panel and may generate regulated and controlled AC power output. The output power supply may be conveyed separately to a power distribution board. The power distribution board may supply the power separately to the equipments, operated on AC power and DC power, respectively.

This application claims benefit of priority from U.S. Provisional Application Ser. No. 60/945,652 filed on Jun. 22, 2007. The entire teachings of these applications are incorporated herein by reference.

### FIELD OF INVENTION

This invention relates to a power conditioning unit (PCU). The power conditioning unit may, for example, be used at telecommunication sites and other like sites.

### BACKGROUND

At the telecommunication sites various electrical and electronic equipments, for example, cooling equipments, base transceiver station (BTS), lighting equipments etc. are installed. These electrical and electronic equipments may be installed in a shelter at the telecommunication sites. Power requirement of these equipments may vary normally in the range of about 220-240 volt AC and about 24-110 volt DC to operate such equipments. Therefore, the power obtained from the power supply sources need to be conditioned by stabilizing and regulating voltage, before supplying to the various equipments, depending upon the power rating and requirement of the equipments.

The power conditioning may be carried out by a power interface unit (PIU) installed at the telecommunication sites. The PIU may comprise an input connection panel, a line conditioner unit (LCU), auto mains failure unit (AMF) and an AC distribution panel. The line conditioner unit used in the conventional PIU may typically work at an efficiency level of about 95-97% and the rectifying circuits may work at an efficiency level of about 90-92%. Therefore, overall efficiency level of the PIU may be about 86-89% of the power supplied to the electrical and electronic equipment accounts to about 86-89%. Thus, a lot of power is lost in transit form input connection panel to the electrical and electronic equipment.

### SUMMARY

To realize some of the advantages and to overcome some of the disadvantages noted above, there is provided A power conditioning unit comprising a line conditioner unit (LCU) to receive input power from a phase selector and to generate required pulse to reduce surge current. An auto main failure (AMF) unit selects input power either from the LCU or a diesel generator. A power distribution board (PDB) supplies alternate current (AC) power to AC operated equipments directly. A control unit monitors functioning of the above components. Energy meters are provided to send readings of input AC power supplied and direct current (DC) power used. A network monitoring system controls overall operation of the power conditioning unit from a remote site.

Another aspect of the disclosed teachings is a power conditioning unit (PCU) comprising a main input power supply panel. A phase selector is coupled to the main input power panel to select a power phase of required voltage. A line conditioner unit (LCU) receives input power from the mains input power panel and to generate required pulse to reduce surge current. An auto main failure (AMF) unit receives power either from the LCU or a diesel generator. A power distribution board (PDB) supplies AC power to AC operated equipments directly. A control unit monitors functioning of the above components. Energy meters are provided to send readings of input AC power supplied and direct current (DC) power used. A network monitoring system controls overall operation of the power conditioning unit from a remote site.

Another aspect of the disclosed teachings is a method to provide regulated and controlled power supply to AC and DC operated telecom equipments comprising receiving main power supply from a main input power panel. Input inrush current is controlled when main power supply is switched on. Surge current is reduced and regulated and controlled power output is generated. Regulated and controlled power output are supplied to power distribution board. Input AC power supplied and consumption of AC and DC power used are determined. Over all functions of a power conditioning unit are controlled from a remote site.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a power conditioning unit.

FIG. 2 illustrates an embodiment of a line conditioner unit.

FIG. 3 illustrates another embodiment of the line conditioner unit.

FIG. 4 illustrates an embodiment of a process which may be implemented by the power conditioning unit of FIG. 1.

### DETAILED DESCRIPTION

In the following detailed description, numerous specific details are described in order to provide a thorough understanding of the invention. However the present invention may be practiced without these specific details. In other instances, well known methods, procedures, components and circuits have not been described in detail so as not to obscure the present invention. Further, example sizes/models/values/ranges may be given, although the present invention is not limited to these specific examples.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

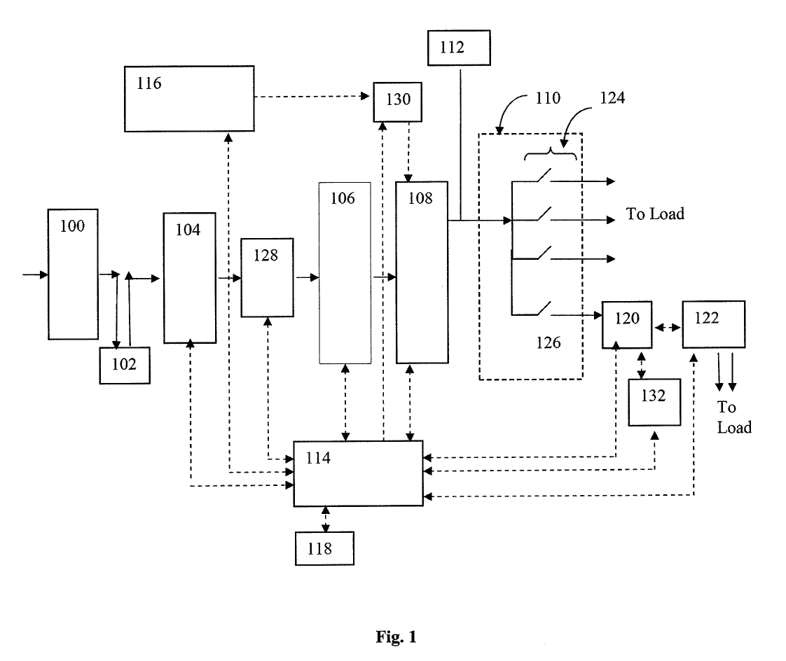

Referring to FIG. 1, an embodiment of a power conditioning unit (PCU) is shown. The power conditioning unit may include a mains input panel 100, a lightning arrestor 102, a phase selector 104, a line conditioner unit (LCU) 106, an auto mains failure (AMF) unit 108, a power distribution board (PDB) 110, a surge arrester 112, a control unit 114, diesel generator (DG) 116, a network monitoring system (NMS) 118, a switch mode power supply (SMPS) 120, batteries 122 and energy meters 128, 130 and 132.

As depicted the mains input panel 100 may be coupled to the phase selector 104 through the lightning arrestor 102. The phase selector 104 may be coupled to the LCU 106 which may be coupled to the AMF unit 108. The AMF unit 108 may be coupled to the power distribution board 110. The surge arrestor 112 may be coupled to the AMF 108 which may be connected to the PDB 110. The control unit 114 may be coupled to the phase selector 104, LCU 106, AMF 108, DG 116, SMPS 120, battery 122, energy meters 128, 130 and 132 and aviation lamp such that to control functioning of these components/instruments. In one embodiment, the control unit 114 may be coupled to different sensors provided at different places and with different devices such that to control temperature and humidity in the shelter and to raise alarm in case of presence of smoke in the shelter. The DG 116 may be coupled to AMF 108 such that to provide power supply in case of failure of the mains power supply. The NMS 118 may be connected to the control unit 114 such that to control overall operation of the power conditioning unit (PCU) from a remote place. Energy meters 128, 130 may be coupled between phase selector 104 and line conditioner unit 106 and DG 116 and AMF 108 such that to send readings of the input AC power supplied. Also an energy meter 132 may be coupled to SMPS 120 such that to send readings of the DC power used.

The mains input panel 100 may receive power from a mains power supply source and transmit the same to the phase selector 104 through a lightning arrestor 102 which may be provided to arrest excess voltage. The phase selector 104 may select two phases of the required voltage out of three phases of the mains power supply and transmit the power supply from the selected phases to the line conditioner unit (LCU) 106. The LCU 106 may regulate input voltage which may be transmitted to the power distribution board 110 through an auto mains failure (AMF) 108. In one embodiment, the LCU 106 may regulate input voltage and generate dual outputs of required voltage. The AMF 108 may be provided to select and supply AC power to the power distribution board 110 either from the mains power supply or from the DG 116. In one embodiment, the AMF 108 may supply power from the DG 116 upon failure of the mains power supply and receiving command from the control unit 114.

The PDB 110 may comprise a set of switches 124 and a switch 126 to receive controlled and regulated voltage and to supply the same to the electrical equipments, for example air conditioners, lights, power points etc. adapted to run on AC power supply and to the SMPS 120, respectively. The SMPS 120 may convert the alternate current (AC) into direct current (DC) and supply the same to DC operated equipments. The SMPS 120 may charge batteries 122 or an array of batteries 122 provided to store and supply DC power to the electronic equipments, for example, base transceiver station (BTS) and other electronic equipments provided in a shelter to facilitate operation of telecommunication site.

In one embodiment and in case of dual power supply by the LCU 106 the PDB may receive plurality of input AC power supply through the AMF 108 at the switches 124 and the switch 126, separately. The switches 124 may supply AC power to AC operated equipments and the switch 126 may supply AC power to the SMPS 120.

The control unit 114, in one embodiment, may determine voltage of each phase of the input power supply and may send signals to the phase selector to select the phase of the required voltage. The control unit 114 may check the functioning of the LCU 106 to process the input power supply to regulate the output voltage. The control unit 114 may check regarding failure of the mains power supply and in case of mains power failure the control unit 114 may send signals to start diesel generator (DG) after a predetermined time interval in order to transmit DG output to PDB 110 through the AMF 108. The control unit 114 may receive signals regarding temperature needed to be maintained in a shelter during operation of a base transceiver station (BTS) provided therein and may switch on and switch off cooling devices, for example, air conditioner as and when required. The control unit 114 determines as to weather the SMPS is properly charging the batteries 112 and supplying the DC voltage to the DC operated equipments. The control unit 114 may receive readings of the input AC power supplied and DC power used from the AC energy meters 128, 130 and 132, respectively and may determine consumption of output AC and DC power supply provided by the PIU. In one embodiment, the PIU may determine as how much power has been used by individual user in case of a common PIU used by the different telecom service providers. In one embodiment, the control unit 114 may monitor functioning of all the components and may raise alarm in case of malfunctioning of any of the components in order to operate telecom equipments smoothly and efficiently.

According to an embodiment, a network monitoring system (NMS) 118 may be coupled with the control unit 114 such that to monitor and control the working functions of all the components, for example, phase selector 104, LCU 106, AMF 108, DG 116, SMPS 120, battery 122, energy meters 128, 130 and 132 and aviation lamp coupled to the control unit 114, from a remote place.

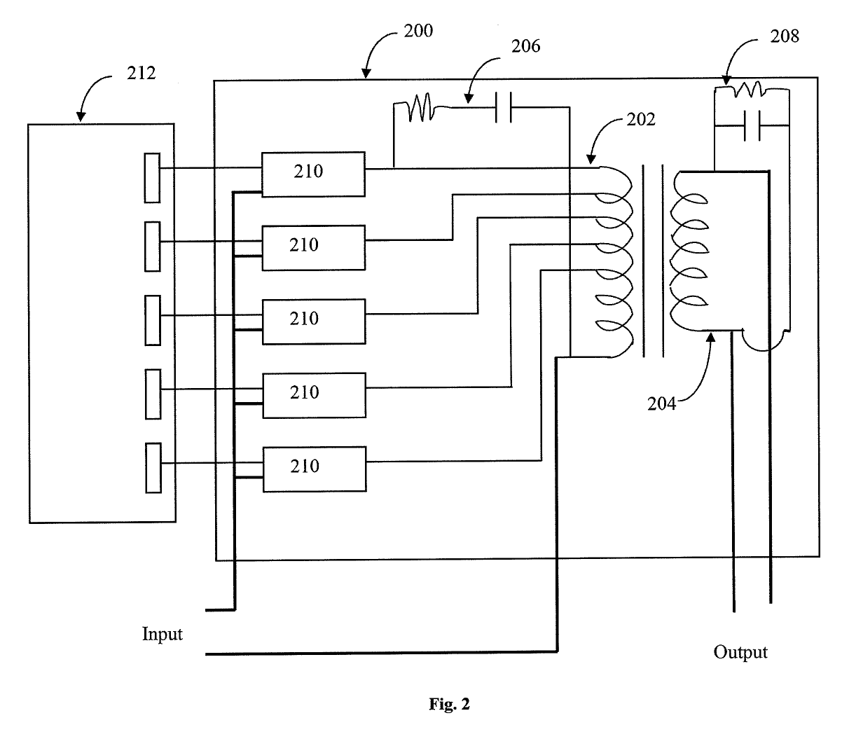

Reference is now made to FIG. 2 which depicts an embodiment of a line conditioner unit (LCU) 106. The LCU 106 may include a transformer 200 comprising a primary coil 202 at input side and a secondary coil 204 at output side of the transformer 200. A resistance-capacitance (R-C) circuit 206 may be coupled with the primary coil to suppress rapid voltage variation. Another R-C circuit 208 may be provided with the secondary coil 204 also to suppress rapid voltage variation. Plurality of silicon controlled rectifiers (SCR) 210 may be coupled to the primary coil 202 provided at the input side of the transformer 200 to control input inrush current at the time of switching on supply from the mains. A control card 212 may be provided to generate required pulse so that surge current is negligible and proper input current may be supplied to the SCRs 210. In one embodiment, the control card 212 may change the firing angle of the SCRs so that the surge current is negligible. Thus, the LCU 106 may receive main input power supply and may regulate and control input power supply to be supplied to the power distribution board 110. The power distribution board 110, in one embodiment, may supply AC power to the electrical equipments operated on AC power and DC power to the electronic equipments operated on the DC power, separately. In another embodiment, the AC power may be received by the PDB 110 and SMPS 120 through the AMF 108, separately.

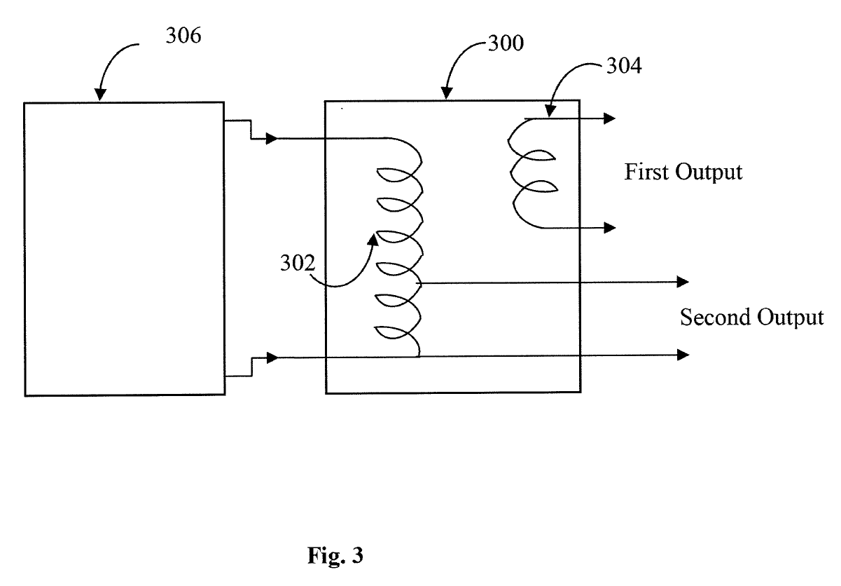

Reference is now made to FIG. 3 which depicts another embodiment of a line conditioner unit (LCU) 106. The LCU 106 may include a transformer 300 comprising a primary coil 302 at input side and a secondary coils 304 at output side such that to provide a first AC outputs of required voltage. In one embodiment, second AC output is obtained by connecting primary coil at to output circuit. A control card 306 may be provided at the input side of the transformer to generate required pulse to reduce surge current and to supply proper input current to the primary coil of the transformer 300.

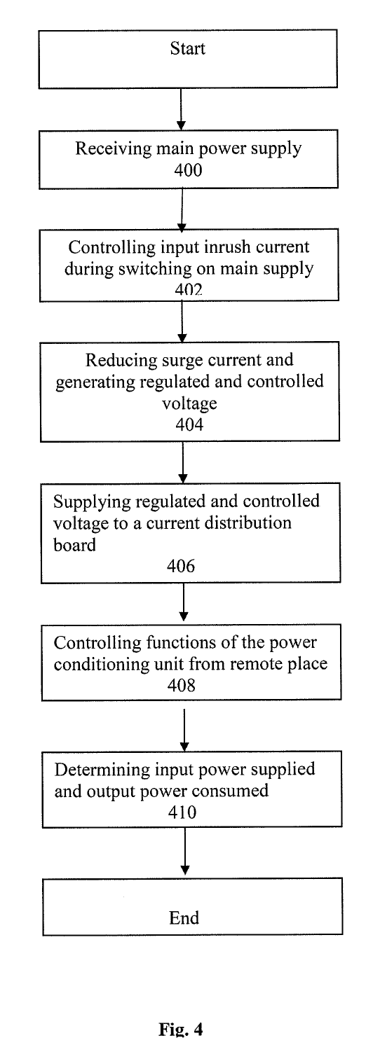

Reference is now made to FIG. 4 which may depict a process of the power conditioner unit. According to an embodiment of the process in block 400 and when power conditioning unit is switched on, the power supply may be received by the mains input panel and transmitted to a line conditioner unit through a lightning arrester and a phase selector.

In block 402, a line conditioner unit (LCU) may receive the power supply from mains input panel and the silicon controlled rectifiers (SCRs) provided on the primary side of the transformer may control input inrush current when main power supply is switched on. In one embodiment, the LCU may generate dual outputs of regulated and controlled alternate current (AC) of the required voltage.

In block 404, the line conditioner unit (LCU) may receive the power supply from mains input panel and the control card of the LCU may send required pulses to minimize starting surge current demand of transformer to negligible and regulate the alternate current (AC) output to generate required voltage. In one embodiment, the LCU may generate dual outputs of regulated and controlled alternate current (AC) of the required voltage.

In block 406, the regulated and controlled output may be supplied to the power distribution board 110 which may convey the output to the electrical and electronic equipment.

In block 408, the network monitoring system may monitor and control overall functions, for example voltage monitoring, fault monitoring, temperature inside the shelter etc. of the power conditioning unit.

In block 410, the control unit 114 may receive inputs from AC and DC energy meters and calculate amount of the input AC power supplied and consumption of AC power and DC power. In one embodiment, the control unit may determine the consumption of the AC power DC power used by different users in case of a common PIU used by the different users.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A power conditioning unit comprising:
a line conditioner unit (LCU) to receive input power from a phase selector and to generate required pulse to reduce surge current;
an auto main failure (AMF) unit to select input power either from the LCU or a diesel generator;
a power distribution board (PDB) to supply alternate current (AC) power to AC operated equipments directly;
a control unit to monitor functioning of the above components;
energy meters provided to send readings of input AC power supplied and direct current (DC) power used; and
a network monitoring system to control overall operation of the power conditioning unit from a remote site.

2. The power conditioning unit of claim 1, wherein the line conditioner unit comprises a transformer having a plurality of silicon controlled rectifier at the input side to control input inrush current when mains power supply is switched on.

3. The power conditioning unit of claim 2, further comprising a control card to control input side power of the line conditioner such that to change firing angle of silicon controlled rectifiers so as to reduce surge current.

4. The power conditioning unit of claim 1, further comprising a lightning arrester coupled between mains input panel and phase selector.

5. The power conditioning unit of claim 4, wherein the phase selector is coupled to the LCU.

6. The power conditioning unit of claim 5, further comprising a surge arrester coupled to an auto mains failure unit.

7. The power conditioning unit of claim 1, wherein the line conditioner unit comprises a single input and dual output transformer having a control card to provide regulated and controlled input current.

8. The power conditioning unit of claim 1, wherein the power distribution board supplies the power to the AC operated equipments, directly.

9. The power conditioning unit of claim 8, wherein the power distribution board supplies the power to the DC operated equipments through a set of batteries.

10. A power conditioning unit (PCU) comprising:
a main input power supply panel;
a phase selector coupled the main input power panel to select a power phase of required voltage;
a line conditioner unit (LCU) to receive input power from the mains input power panel and to generate required pulse to reduce surge current;
an auto main failure (AMF) unit to receive power either from the LCU or a diesel generator;
a power distribution board (PDB) to supply AC power to AC operated equipments directly;
a control unit to monitor functioning of the above components;
energy meters provided to send readings of input AC power supplied and direct current (DC) power used; and
a network monitoring system to control overall operation of the power conditioning unit from a remote site.

11. The power conditioning unit of claim 10, further comprising a lightning arrester coupled between main input panel and phase selector.

12. The power conditioning unit of claim 10, wherein the line conditioner unit comprises transformer having a plurality of silicon controlled rectifier at the input side to control input inrush current when main power supply is switched on.

13. The power conditioning unit of claim 12, further comprising a control card to control input side of the line conditioner such that to change firing angle of silicon controlled rectifiers so as to reduce surge current.

14. A method to provide regulated and controlled power supply to AC and DC operated telecom equipments comprising:
receiving main power supply from a main input power panel;
controlling input inrush current when main power supply is switched on;
reducing surge current and generating regulated and controlled power output;
supplying regulated and controlled power output to power distribution board;
determining input AC power supplied and consumption of AC and DC power used; and
controlling over all functions of a power conditioning unit from a remote site.

15. The method of claim 14, wherein a line conditioner unit (LCU) receives the mains power supply from the mains input power panel through a lightning arrestor.

16. The method of claim 15, wherein the LCU receives the mains power supply from the mains input power panel through a phase selector.

17. The method of claim 16, wherein the inrush current is controlled by silicon controlled rectifiers provided at input side of a transformer.

18. The method of claim 17, wherein the inrush current is controlled by silicon controlled rectifiers when mains power supply is switched on.

19. The method of claim 17, wherein the surge current is reduced by changing firing angle of the silicon controlled rectifiers.

20. The method of claim 18, wherein the LCU receives a single input power and generates a plurality of outputs.

21. The method of claim 14 wherein the power distribution board receives controlled and regulated power supply from the LCU through an auto mains failure unit.

22. The method of claim 21, wherein the power distribution board receives plurality of controlled and regulated power supply through an auto mains failure unit, separately.

23. The method of claim 22, wherein the power distribution board supplies the power to AC operated equipments, directly.

24. The method of claim 23, wherein the power distribution board supplies the power to DC operated equipments through a battery.
